(19) United States
(12) Patent Application Publication
(10) Pub. No.: US 2002/0198826 A1
(43) Pub. Date: Dec. 26, 2002

(54) Method and system for transferring funds and video messages

(76) Inventors: Max Wasserman, Villa Fontana, PR (US); Manuel Hernandez, Mexico City (MX)

Correspondence Address: CONNORS ASSOCIATES, 1600 DOVE ST, SUITE 220, NEWPORT BEACH, CA, 92660

(21) Appl. No.: 10/082,364

(22) Filed: Feb. 25, 2002

Related U.S. Application Data
(60) Provisional application No. 60/271,919, filed on Feb. 27, 2001.

(51) Int. Cl. G06F 17/60

(52) U.S. Cl. 705/39

(57) ABSTRACT

A system for transferring funds and a video message employs an enclosure at a local station managed by a local agent. The enclosure includes recording equipment and a telephone linked by an automatic dialer to a call center that takes an order from the sender to transfer funds to a beneficiary at a remote destination. The recording equipment records the video message after the order is taken. The video message is forward to a remote agent at the remote destination from whom the beneficiary redeems the funds and is given the video message.

### RELATED PATENT APPLICATION

This application is a utility application based on U.S. provisional based on U.S. provisional patent application Ser. No. 60/271,919, entitled “Method and System for Transferring Funds and Video Messages,” filed Feb. 27, 2001. This related application is incorporated herein by reference and made a part of this application. Moreover, Applicants hereby incorporate herein by reference, any and all U.S. patents, U.S. patent applications, and other documents and printed matter cited or referred to in this application.

### BACKGROUND OF INVENTION

The wire transfer industry has been in existence for more than 100 years. During this period it has become the number one source of sending money back home for immigrants, particularly from in the United States to other countries. There are three kinds of wire transfers being performed here in the United States:

1—Banking Wires: used for financial needs, such as business deals, transferring of accounts, mostly high balances, only from bank to bank.

2—Domestic Wires: used for transferring small amounts within the United States. This service is dominated by Western Union and Money Gram. This service is usually used for college students, the military, and family members in need.

3—International Wire Transfer: used mostly by immigrants to send money back home. The average wire transfer amount is about $300.00 US dollars.

For the last century the international wire transfer business has grown beyond most expectations. There are now over 300 companies that offer the service of transferring funds mainly to Mexico, Central America, and South America. Companies have searched for better and more cost effective ways to transfer funds from the United States to destinations in other countries. Costs, as well as competition, have forced competitors to look for better or different kinds of service to maintain market share. Companies through out the years have created new ways to send money and to cut the cost related to this service. “Friendly User” has been the general goal for the companies due to the fact that most of the users or senders are immigrants, and a many are illiterate and speak a different language than English.

Initially, the person desiring to make a wire transfer had to enter a financial institution, for example, a bank, and order a wire transfer. This made it difficult to attract customers, since the immigrants were afraid to enter a “financial institution.” They thought they would be “deported.” In the beginning of the last century, the major wire transfer companies, e. g. Western Union and Money Gram, “the leaders,” introduced an aggressive marketing campaign in the United States by recruiting nation-wide small “mom and pop” shops, to serve as the agent or the “Affiliated Store.” This practice allowed many immigrants to feel more secure and at ease at the time of entering a “mom and pop” shop to send or receive money. These stores or shops were conveniently located, being placed strategically in neighborhoods in cities were the presence of banks were restricted or in the farming communities heavy populated by immigrants.

The major wire transfer companies recruited the store or shop as an agent and supply it with all the necessary products and materials to perform an outgoing or incoming wire transfer. It was a success. With the years to come, more and more companies invaded the wire transfer industry seeking the opportunity to participate in the revenues generated from this type of service. The agent became more interested in offering this type of service to its customers, due to the tremendous foot traffic generated at its store location. The system was great! But something was missing. Because many of the senders were immigrants and many did not now how to speak English, even how to reed or write, the industry was forced to come up with a better and faster way to send money.

The major wire transfer companies used, and still use in many cases. a primitive service referred to as the “Form.” A customer enters a location, the Affiliated Store, and requests a form to send money. They fill out the information requested on the form and deliver it to the attendant or the storeowner. The information is then called into a main operation station, or in some cases due to the store's large volume, to a computer issued by the major wire transfer company. The information is entered and sent. The basic problem is that neither the storeowner nor the sender knew how to write the names of the beneficiaries or the cities were the money is going to be received. About 98% of all wires being performed were headed to third world countries. Although this service was obsolete, it works, and today over 1.5 million senders still utilize the Form.

Competitors of the major wire transfer companies immediately started to look for better and faster ways to transfer funds. They wanted to offer an easier way of sending the money at the store itself. During the last decade the “hot phone,” the name given in the industry, was created. It was a phone utilized for many years in airports, catalog services, at department stores, and in many customers service businesses through the United States. The phone did not have a keypad. The customer simply lifted up the headset, and though an automatic dialer, programmed by the wire transfer company, the sender at the store would be connected to the company's call center. At this call center, an operator speaking the same language as the customer, would assist the customer in performing the wire transfer. No more did the storeowner or the sender have to deal with the language barrier.

### SUMMARY OF INVENTION

The present invention provides an improved wire transfer system and method to send conveniently a personal video message at the same time that a wire transfer of funds is being executed. The invention has several features. Without limiting the scope of this invention as expressed by the claims that follow, its more prominent features will now be discussed briefly. After considering this discussion, and particularly after reading the section entitled, “DETAILED DESCRIPTION,” one will understand how the features of this invention provide its benefits, which include, but are not limited to, quickly and conveniently sending a video message with a wire transfer to a remote location, typically from one country to another country.

The first feature of the system of this invention is that it enables the sender to create conveniently and quickly a personalized video message when he or she is sending money to relatives, friends, and other beneficiaries at a remote destination, most likely, their native country. This novel system includes a local station where the sender initiates a transaction including recording a video message and placing an order to transfer funds to a beneficiary at a remote destination. A call center takes the order and the transaction is identified, typically with a unique numerical or alpha-numerical code. This codes enables each specific transaction to be tracked to insure timely and accurate delivery of the video message and funds to the proper beneficiary. The sender calls by telephone, or otherwise notifies the beneficiary of the code, and the beneficiary provides this code to an agent at the remote destination responsible for delivering the video message and funds to the proper beneficiary. This code is necessary to redeem the video message and funds at the remote destination. A receipt, including the code, is provided at the local station for approval by the sender. In addition to the code, the receipt preferably should state the amount of the funds transferred, the exchange rate, name of the beneficiary, and the remote destination. The call center issues the receipt and typically sends a fax to the sender at the local station concurrent with transaction for the signature of the sender. A signed copy is retained by both the local agent and the sender. A copy may be transmitted, for example by fax to the call center.

The second feature is a telephone at the local station and recording equipment that records the video message. Preferably, an automatic dialer links the telephone to the call center. The telephone includes a conventional headset that normally is positioned to disconnect the telephone and the call center. The sender picks up the headset to manually move the headset into a call position. In this call position, a telephone call is automatically initiated by the automatic dialer, connecting the sender to the call center. Convention video recording equipment is used that includes an audio recorder that simultaneously records a voice message with the recording of the video message. Such convention video recording equipment includes a camera and a microphone that the sender accesses at the time of conducting the transaction. The recording equipment is activated at the time the order is placed to record the video message of the sender, preferably after the code is provided. The duration of the visual and audio messages may be from a few seconds to a few minutes, e.g., from 5 seconds to fifteen minutes. An audio or visual indicator is turned on when the recording equipment is activated. Both the visual and audio messages are preferably digitized for transmission over a computer network. In some instances it may be desirable or necessary because the remote destination cannot be link to a computer network, the video message is recorded on a tangible media such as a VCR video tape or compact disk (CD) that is sent via mail to the remote destination.

The third feature is that the video message is stored at a storage station for subsequent delivery to the beneficiary. A computer network links the local station to the storage station and the remote destination. This computer network may be a private network or open to the public such as the global computer network commonly referred to as the Internet or World Wide Web. This such transmission of the message or messages is low cost and convenient. The funds are transmitted in the conventional manner and, as usual, the money making benefit is on arbitrage or differential in exchange rates. For example, the operator of the system buys with United States dollars large amounts of Mexican pesos at one exchange rate and sells these pesos to a sender in the United States at a higher exchange rate, making a profit with each sale. The present invention gives the sender an added incentive to buy pesos from the operator of the system because the sender can give the beneficiary a personalized video message when the funds are delivered.

The fourth feature is that a local agent manages the local station and receives a commission for the transaction. Consequently, once the system is operational, very little additional costs is attributable to the management of the local stations, because there are no salaries for employees at the local station. There is a computer at the local station for the control and communication, typically a conventional personal computer (PC). This computer has a memory that stores (i) information concerning the transaction, (ii) the code identifying the transaction, and (iii) the local station or agent from which a sender is conducting a transaction.

The fifth feature is the local station itself. This local station comprises an enclosure providing a recording zone for the sender to record the video message. This enclosure has at least one open side to provide the sender with access to the recording zone, and it includes the recording equipment and telephone. The headset of the telephone and the camera and microphone of the recording equipment are located with the recording zone in position to facilitate capturing an image of the sender and his voice message. The indicator is also in this zone so the sender is notified when the recording equipment has been activated. When the sender picks up the headset to manually move the headset into the call position, the call center instructs the sender to look at the camera, hang up the headset, and speak into the microphone. Usually a live operator is at the call center to take the call and enter data in a main server or hub concerning each specific transaction, speaking to the sender in his or her native language. Automated communication devices with voice synthesizers that generating synthesized voice prompts and a keyboard input for the sender to enter data may also be used. The computer network links the recording equipment to the storage station and transmits a recorded video message via the computer network to the storage station. The call center controls the activation of the indicator and the recording equipment.

This invention also includes a number of related methods where a sender sends a video message and transfers funds to a beneficiary at a remote destination. These methods are set forth in the CLAIMS and disclosed in the following the section entitled, “DETAILED DESCRIPTION.”

### DESCRIPTION OF DRAWINGS

The preferred embodiment of this invention, illustrating all its features, will now be discussed in detail. This embodiment depicts the novel and non-obvious method and system of this invention for transferring funds and video messages as shown in the accompanying drawings, which are for illustrative purposes only. These drawings include the following figures (Figs.), with like numerals indicating like parts:

FIG. 1 is a schematic illustration of a portion of the system of this invention located at a local station managed by a local agent that enables the sender to make a video message that is forwarded to a beneficiary at a remote destination.

FIG. 2 is a schematic illustration of an array of enclosures like the one depicted in FIG. 1 used at the local station.

FIG. 3 is a schematic illustration of the entire system for transferring funds and a video message according to this invention.

### DETAILED DESCRIPTION

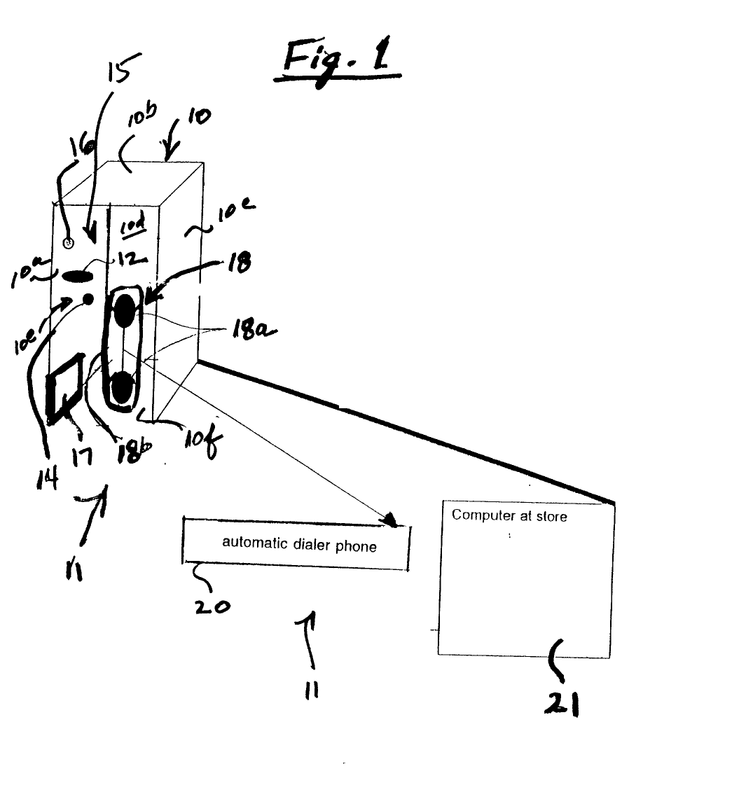

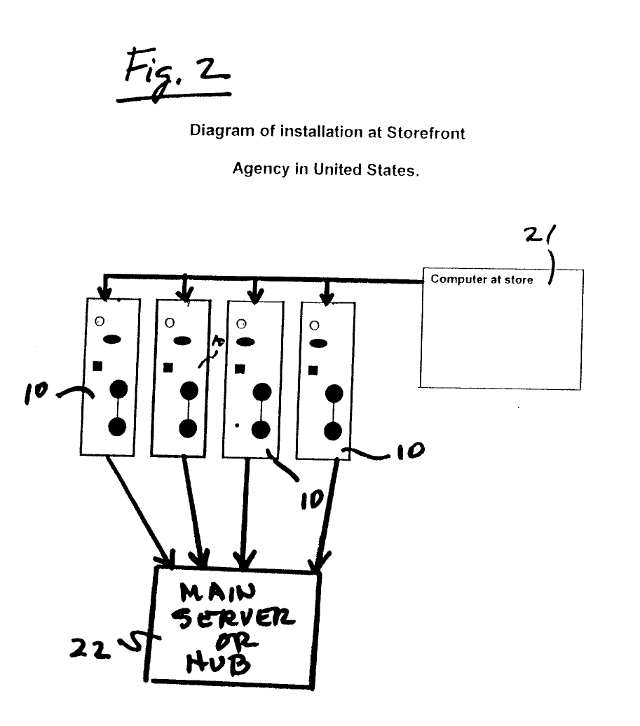

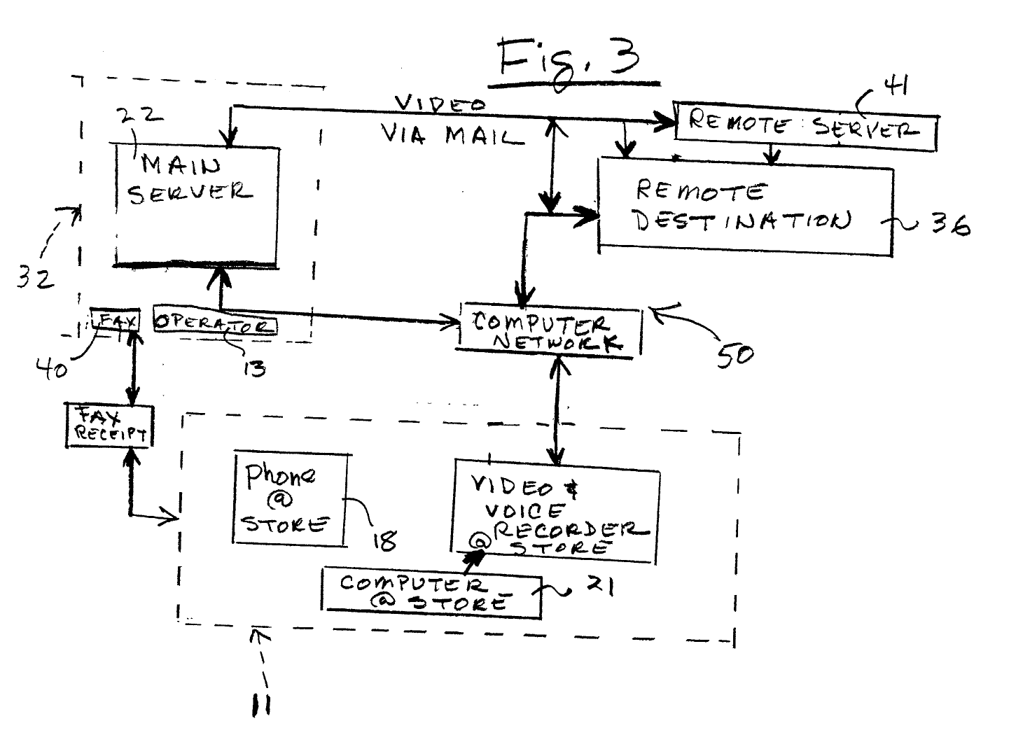

As depicted in FIG. 1, there is located at a local agent's store, referred to herein as the local station 11 (FIGS. 1 and 3), a video recording enclosure 10 that enables a sender to order concurrently a funds wire transfer and create a video message. The enclosure 10 has opposed vertical side walls 10a and 10c, a top wall 10b, and a back wall 10d. A front side 10e and a bottom 10f of the enclosure are open to provide the sender with access to a recording zone 15 within the interior of enclosure 10. The enclosure 10 is mounted on a stand (not shown) and is of heavy duty, metal construction similar to public pay phones telephones. Within the enclosure 10 is a data board 17 utilized in the recording of the video and voice messages and the video data collection mechanism including a camera 12, a microphone 14, an indicator light 16, and a telephone 18, including a headset 18a normally resting in a cradle 18b. When the sender lifts the headset from the cradle 18b, an automatic dialer 20 connects the telephone 18 to a call center 32, including a main server 22 (FIGS. 2 and 3) that serves as a storage station for storing data concerning each individual transaction conducted. A computer 21 is located at each station 11 for control and communication purposes. One computer 21 may control a number of separate enclosures 10 located at an individual local station 11 as depicted in FIG. 2.

The camera 12 is of digital quality, but not a zoom, in order to avoid bad recording, and it should be flush mounted against an inner surface of a wall of the enclosure 10 and is of industrial quality due to ware and tear and hard handling. The microphone 14 is flush mounted against an inner surface of a wall of the enclosure 10, and preferably of metal only. This microphone 14 preferably has a voice sensor in order to adjust volume control due to different voice pitch. The indicator light 16 is also flush mounted against an inner surface of a wall of the enclosure 10 and of heavy-duty construction in order to avoid tampering.

The cradle 18b for the headset 18a, also of industrial quality, is attached to an inner surface of a wall of the enclosure 10 and does not have a dial pad. A dial pad is not needed, since the telephone 18 is always connected to the same phone number. The sender initiates a telephone call by removing the headset 18a from its cradle 18b. When removed from the cradle 18b, the headset 18a is automatically connected to a live operator 13 at the call center 32 by the automatic dialer 20.

This invention combines the existing phone service used for money transfers with modern video and data collection technology to capture the funds wire transfer and at the same time record a video message, which may be of any short duration. Thus the invention combines a regular money transfer and a video message. The video recording enclosure 10 is placed at the local agent's station 11. When the sender decides to order a video and funds wire transfer, he or she conducts the following operations:

1—The sender enters the recording zone 15 in the enclosure 10 and picks up the headset 18a to activate the automatic dialer 20. This connects the sender to the call center 32 (FIG. 3) to conduct a live conversation with the operator 13 who takes the order for the money transfer.

2—The operator 13 asks the sender to provide the agent's number corresponding the location of the station 11, and when multiple enclosure are at the same station 11, to identity of the enclosure. This information is needed to credit and pay a commission on the transaction to the local agent managing the local station 11 at which the transaction occurs.

3—Once communication is established, the operator also captures the information concerning the beneficiary, specifically the beneficiary's name and destination, and the name of the sender of the wire.

4—Once all the necessary or desired information about the funds wire transfer has been captured, the operator 13 instructs the sender that when the indicator light 16 is activated, he or she should look in to the camera 12, hang up the headset 18a and speak into the microphone 14.

5—The operator activates of the camera 12 remotely from the call center 32. As shown in FIG. 2, the computer 21 is connected to the individual enclosures 10 in station 11. This computer 21 activates each of these individual enclosures when being used. Each enclosure 10 has a number or letter identifying the specific enclosure being used by the sender. Each of these numbers or letters is already imputed into the agent's record and database in the main server 22 to identify properly the individual enclosure being used by a sender.

6—The operator presses a print button (not shown) at the call center 32 to print a receipt 42 and activate a fax machine 40. This receipt 42 states the amount of the funds transferred, the exchange rate, name of the beneficiary, the remote destination, and a code identifying the transaction. The code has a first portion identifying the local agent, and when required, the enclosure, a second portion identifying the remote destination, and a third portion identifying the transaction for tracking and delivery. With this action the following occurs:

a. The fax receipt 34 with the information about the video and wire transfer is automatically sent to the local agent at the station 11 where the transaction is being conducted for approval and signature by the sender and the agent. This signed faxed is then faxed to the call center 32 to confirm that the sender has deposited the funds with the local agent and the information concerning the transaction is accurate.

b. The code is assigned by the main server 22 to identify the origin of the video and wire transfer and the tracking of the video message and wire transfer transaction.

c. The camera is activated and a message with voice and video data is recorded.

7—Once the video message is recorded at the local station 11, it is sent in digital format to the main server 22 by the computer 21 via a communication link such as a computer network 50. Preferably, the information concerning each individual transaction retained in the the main server 22 and storage station is filed or organized according to the final destination to which they are to be sent. Preferably, a batch of messages and funds transfer wires are sent to and stored in a remote server 41 located in the same country as the remote destination 36. All these stored messages and funds transfer wires for a given destination are sorted by each destination in the country of the destination and are forwarded at once in a batch to this destination. Typically, a D.S.L/Frame relay line connects the local station 11 to the storage station 22 and the main server 22 to the server 41. When the stored and recorded video message is subsequently sent to a final remote destination 36 (FIG. 3), an agent at this destination delivers it to the beneficiary so it can be played and also pays out the funds. The code on the receipt 42 and provided by the sender to the beneficiary, preferably along with suitable ID such as a driver's license, is used insure the funds and message is being deliver to the proper person.

8—In some very remote cities in Mexico, Central, and South America, their is no connection trough D.S.L/frame relay or even a phone line. In those cases the video message will be recorded on, for example, a video tape, diskette, or compact disk (C. D.) and sent via mail to the remote agent located at the intended final destination 36.

9—The beneficiary then visits the remote agent located at the intended final destination 36 and redeems the money and the video message.

Once the money and the video message are redeemed, the video message can be saved or erased at the discretion of the remote agent located at the intended final destination 36.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiment disclosed. On the contrary, the intention is to cover all modifications and alternate constructions coming within the spirit and scope of the invention as generally expressed by the following claims, which particularly point out and distinctly claim the subject matter of the invention:

1. A system for sending a video message and transferring funds, comprising
a local station where a sender initiates a transaction including recording a video message and placing an order to transfer funds to a beneficiary at a remote destination,
a call center that takes the order and identifies the transaction to enable the beneficiary to redeem the video message and funds at the remote destination, and
a storage station at which the video message is storage for subsequent delivery to the beneficiary.

2. The system of claim 1 where the storage station is linked by a computer network to the remote destination.

3. The system of claim 1 where the transaction is identified by a code that is provided to the sender.

4. The system of claim 1 where the call center is linked to the local station by a telephone with an automatic dialer.

5. A system for sending a video message and transferring funds, comprising
a local station where a sender initiates a transaction including recording a video message and placing an order to transfer funds to a beneficiary at a remote destination, said transaction being identified by a code that is provided to the sender,
a call center that takes the order and identifies the transaction to enable the beneficiary to redeem the video message and funds at the remote destination, said call center being linked to the local station by a telephone with an automatic dialer, and
a storage station at which the video message is storage for subsequent delivery to the beneficiary, said storage station being linked by a computer network to the remote destination.

6. A system for sending a video message and transferring funds, comprising
a local station where a sender initiates a transaction including recording a video message and placing an order to transfer funds to a beneficiary at a remote destination,
said local station including
(i) a telephone linked to a call center that takes the order and provides the sender with a code identifying the transaction and
(ii) recording equipment that records the video message, said recording equipment being activated at the time the order is placed to record the video message of the sender, and
a storage station to which the video message is transmitted for storage, said storage station being linked to the remote destination to subsequently forward the stored video message to the remote destination upon presentation of the code.

7. The system according to claim 6 where the telephone includes a headset that normally is positioned to disconnect the telephone and the call center and is manually moved into a call position when a call is initiated to activate an automatic dialer that connects the sender to the call center.

8. The system according to claim 7 where the recording equipment is capable of recording both a visual image and an audio message and includes a camera, a microphone, and an indicator that is turned on when the recording equipment is activated.

9. The system of claim 8 where a local agent manages the local station and receives a commission for the transaction, said system including a computer having a memory storing (i) information concerning said transaction, (ii) the code identifying said transaction, and (iii) the local agent.

10. The system according to claim 9 where the code is provided to the sender at the time the order is placed to identify the transaction and the local agent credited with the commission.

11. The system according to claim 9 where a receipt is provided at the local station for approval by the sender.

12. The system according to claim 11 where said receipt states the amount of the funds transferred, the exchange rate, name of the beneficiary, the remote destination, and the code identifying the transaction.

13. The system according to claim 6 where the code enables the video message to be tracked.

14. The system according to claim 6 where the video message is transmitted to the storage station via a computer network.

15. The system according to claim 6 where the video message is transmitted to the remote destination via a computer network.

16. The system according to claim 6 where the video message is recorded on a media that is sent via mail to the remote destination.

17. A system for sending a video message and transferring funds, comprising
a local station managed by a local agent where a sender conducts a transaction including recording a video message and placing an order to transfer funds to a beneficiary at a remote destination,
said local station including an enclosure where the video message is recorded having
(i) a telephone, including a headset, linked by an automatic dialer to a call center that takes the order to transfer funds to the beneficiary at a remote destination, and
(ii) recording equipment to record the video message, said recording equipment including a camera, a microphone, and an indicator that is activated when the recording equipment has been turned on,
said recording equipment, including the indicator, being turned on after the transaction has been initiated and the sender has been instructed to look at the camera, hang up the headset, and speak into the microphone, and
a storage station to which the video message is transmitted for storage, said storage station being linked to the remote destination to enable the stored video message to be subsequently forwarded to said remote destination where the beneficiary redeems the funds and video message.

18. The system according to claim 17 where the video message is transmitted to the storage station via a computer network.

19. The system according to claim 17 where the video message is transmitted to the remote destination via a computer network.

20. The system according to claim 17 where the video message is recorded on a media that is sent via mail to the remote destination.

21. The system according to claim 17 including a computer having a memory, said computer programmed to store in the memory (i) amount of funds being transmitted by the sender and (ii) a code identifying the transaction.

22. The system according to claim 21 where the code is provided at the time the transaction is initiated and identifies the video message and the local agent in order to credit the local agent with a commission and enable the beneficiary to redeem the funds at the remote destination.

23. The system according to claim 22 where the recording equipment is activated after the code is provided.

24. The system according to claim 17 where a receipt is provided at the local station for approval by the sender.

25. The system according to claim 24 where said receipt states the amount of the funds transferred, the exchange rate, name of the beneficiary, the remote destination, and the code identifying the transaction.

26. The system according to claim 21 where said code enables the video message to be tracked.

27. A method where a sender sends a video message and transfers funds to a beneficiary at a remote destination, said method comprising the steps of
(a) initiating at a local station a transaction including recording a video message and placing an order to transfer funds to the beneficiary at the remote destination,
(b) recording at said local station the video message of the sender, and
(c) sending the video message to the remote destination to be redeemed by the beneficiary at the time the beneficiary redeems the funds upon the beneficiary providing acceptable identification.

28. The method according to claim 27 where the transaction is identified by a code assigned to the transaction with the recording of the video message, said code serving as the acceptable identification.

29. A method where a sender sends a video message and transfers funds to a beneficiary at a remote destination, said method comprising the steps of
(a) initiating at a local station a transaction including recording a video message and placing an order to transfer funds to the beneficiary at the remote destination,
(b) recording at said local station the video message of the sender,
(c) transmitting the video message for storage to a remote storage station,
(d) identifying the transaction, including the amount of funds being transferred and the video message, with a code,
(e) transmitting the code to the beneficiary, and
(f) subsequently forwarding the stored video message from the storage station to the remote destination upon presentation of the code.

30. The method according to claim 29 where a local agent manages the local station and receives a commission for an order.

31. The method according to claim 30 where the code is provided to the sender at the time the order is placed to identify the transaction and the local agent credited with the commission.

32. The method according to claim 31 where a receipt is provided at the local station for approval by the sender.

33. The method according to claim 32 where said receipt states the amount of the funds transferred, the exchange rate, name of the beneficiary, the remote destination, and the code identifying the transaction.

34. The method according to claim 29 where a call center takes the order from the sender, said call center being linked by a telephone to the local station.

35. The method according to claim 34 where the local station includes recording equipment that is activated by an operator at the call center at the time the order is placed to record the video message of the sender.

36. The method according to claim 35 where the recording equipment is capable of recording both a visual image and an audio message and includes a camera, a microphone, and an indicator that is turned on when the recording equipment is activated by the operator.

37. The method according to claim 34 where the telephone includes a headset that normally is positioned to disconnect the telephone and the call center and is manually moved into a call position when a call is initiated to activate an automatic dialer that connects the sender to the call center.

38. A method where a sender sends a video message and transfers funds to a beneficiary at a remote destination, said method comprising the steps of
(a) providing an enclosure at a local station managed by a local agent, said sender recording the video message at the local station and said enclosure having
(i) a telephone, including a headset, linked by an automatic dialer to a call center, and
(ii) recording equipment to record the video message, said recording equipment including a camera, a microphone, and an indicator,
(b) an operator at the call center taking an order from the sender to transfer funds to the beneficiary at the remote destination,
(c) said operator, after the order is taken, activating said indicator and instructing the sender to look at the camera, hang up the headset, and speak into the microphone,
(d) transmitting the video message to a storage station,
(e) after storing in said storage station, forwarding the video message to a remote agent at said remote destination, and
(f) giving the video message and the funds to the beneficiary upon the beneficiary providing acceptable identification.

39. The method according to claim 38 where the sender picks up the headset to activate the automatic dialer to connect the sender with the operator at the call center to conduct a live conversation with the operator.

40. The method according to claim 38 where the identity of the local agent is obtained to credit the order to said local agent.

41. The method according to claim 38 where the operator obtains from the sender the identity of the beneficiary and the identity of the sender.

42. The method according to claim 38 where the operator activates the camera.

43. The method according to claim 38 where the operator authorizes the following:
(a) the generation of a receipt with the information about the order, said receipt being sent to the local agent and sender for approval,
(b) the generation of a code that identifies the order, the origin of the order, and facilitates tracking of the video message.

44. The method according to claim 38 where the sender provides the beneficiary with the code for redeeming the funds and video message upon presentation at the remote destination.

45. An apparatus for sending a video message and transferring funds, comprising
means for establishing a local station where a sender initiates a transaction including recording a video message and placing an order to transfer funds to a beneficiary at a remote destination,
means for taking the order and identifying the transaction with a code to enable the beneficiary to redeem the video message and funds at the remote destination, and
means for storing the video message for subsequent delivery to the beneficiary.

46. The apparatus according to claim 45 where the storage means is linked by a computer network to the remote destination.

48. The apparatus according to claim 46 where the means establishing the local station is linked by a computer network to the means for taking the order and identifying the transaction with a code.

49. A station where a sender sends a video message and places an order to transfers funds to a beneficiary at a remote destination, said station comprising
an enclosure providing a zone for the sender to record the video message, said enclosure including
(i) a telephone having a headset, said telephone linked by an automatic dialer to a call center, and
(ii) recording equipment to record the video message, said recording equipment including a camera, a microphone, and an indicator to notify the sender when the recording equipment has been activated.

50. The station according to claim 49 where the call center controls the activation of the indicator and the recording equipment.

51. The station according to claim 49 where the recorded video message is transmitted a computer network to a storage station.

52. The station according to claim 49 where the enclosure has at least one open side to provided for the sender access to the zone.

53. A station where a sender sends a video message and places an order to transfers funds to a beneficiary at a remote destination, said station comprising
an enclosure providing a zone for the sender to record the video message and having at least one open side to provided for the sender access to the zone, said enclosure including
recording equipment to record the video message, said recording equipment including a camera, a microphone, and an indicator to notify the sender when the recording equipment has been activated,
a computer network that links the recording equipment to a storage station and transmits a recorded video message via said computer network to the storage station, and
a telephone having a headset, said telephone linked by an automatic dialer to a call center controls the activation of the indicator.
